(19) United States
(12) Patent Application Publication
(10) Pub. No.: US 2026/0057268 A1
(43) Pub. Date: Feb. 26, 2026

(54) QUANTUM RANDOM NUMBERS WITH DYNAMIC QUANTUM CIRCUITS

(71) Applicants: International Business Machines Corporation, Armonk, NY (US); Mitsubishi Chemical Corporation, Tokyo (JP)

(72) Inventors: Ikko Hamamura, Tokyo (JP); Rudy Raymond Harry Putra, Yokohama-shi (JP); Shu Kanno, Tokyo (JP); Qi Gao, Tokyo (JP)

(21) Appl. No.: 18/777,643

(22) Filed: Jul. 19, 2024

(51) Int. Cl. G06N 10/20; G06F 7/58

(52) U.S. Cl. CPC G06N 10/20; G06F 7/588

(57) ABSTRACT

One or more systems, devices, computer program products and/or computer-implemented methods of use provided herein relate to implementing quantum random numbers with dynamic quantum circuits. For example, a system can comprise a memory and a processor that can execute computer executable components stored in the memory, wherein the computer executable components can comprise a quantum circuit generation component that can generate a dynamic quantum circuit, wherein generating the dynamic quantum circuit can comprise applying, via a quantum random number component, a first set of quantum operations to one or more qubits, wherein the first set of quantum operations can be executable to generate one or more quantum random numbers. The generating can further comprise applying, via a quantum random measurement component, a second set of quantum operations to the one or more qubits, wherein the second set of quantum operations can be conditional upon the one or more quantum random numbers.

### BACKGROUND

The subject disclosure relates to quantum computing and, more specifically, to employing quantum random numbers with dynamic quantum circuits.

### SUMMARY

The following presents a summary to provide a basic understanding of one or more embodiments described herein. This summary is not intended to identify key or critical elements, delineate scope of particular embodiments or scope of claims. Its sole purpose is to present concepts in a simplified form as a prelude to the more detailed description that is presented later. In one or more embodiments described herein, systems, computer-implemented methods, apparatus and/or computer program products that enable the implementation of quantum random numbers with dynamic quantum circuits are discussed.

According to an embodiment of the present invention, a system is provided. The system can comprise a memory that can store computer executable components. The system can additionally comprise a processor that can execute the computer executable components stored in the memory, where the computer executable components can comprise a quantum circuit generation component that can generate a dynamic quantum circuit, where generating the dynamic quantum circuit can comprise applying, via a quantum random number component, a first set of quantum operations to one or more qubits, where the first set of quantum operations can be executable to generate one or more quantum random numbers. The generating can further comprise applying, via a quantum random measurement component, a second set of quantum operations to the one or more qubits, where the second set of quantum operations can be conditional upon the one or more quantum random numbers.

According to various embodiments, the above-described system can be implemented as a computer-implemented method or as a computer program product.

### BRIEF DESCRIPTION OF THE DRAWINGS

One or more embodiments are described below in the Detailed Description section with reference to the following drawings:

FIG. 1 illustrates a block diagram of an example, non-limiting system that can generate and execute dynamic quantum circuits with quantum random numbers in accordance with one or more embodiments described herein.

FIG. 2 illustrates a block diagram of an example, non-limiting system that can generate and execute dynamic quantum circuits with quantum random numbers in accordance with one or more embodiments described herein.

FIG. 3 illustrates a schematic of an example, non-limiting quantum circuit that can be employed to execute quantum algorithms.

FIG. 4 illustrates a schematic of an example, non-limiting dynamic quantum circuit that can be executed to generate quantum random numbers and selectively execute quantum operations based on the quantum numbers in accordance with one or more embodiments described herein.

FIG. 5 illustrates a schematic of an example, non-limiting quantum circuit that can be executed to generate quantum random numbers in accordance with one or more embodiments described herein.

FIG. 6 illustrates schematics of example, non-limiting quantum circuits that can be employed to execute quantum algorithms.

FIG. 7 illustrates example, non-limiting flow diagrams that show the measurement bases applicable to different quantum computational problems in accordance with one or more embodiments herein.

FIG. 8 illustrates a schematic of an example, non-limiting quantum circuit in accordance with one or more embodiments described herein.

FIG. 9 illustrates example, non-limiting decision diagrams (DDs) in accordance with one or more embodiments described herein.

FIG. 10 illustrates a flow diagram of an example, non-limiting method that can generate and execute dynamic quantum circuits with quantum random numbers in accordance with one or more embodiments described herein.

FIG. 11 illustrates a block diagram of an example, non-limiting operating environment in which one or more embodiments described herein can be facilitated.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

According to an embodiment of the present invention, a system is provided. The system can comprise a memory that can store computer executable components. The system can additionally comprise a processor that can execute the computer executable components stored in the memory, where the computer executable components can comprise a quantum circuit generation component that can generate a dynamic quantum circuit, where generating the dynamic quantum circuit can comprise applying, via a quantum random number component, a first set of quantum operations to one or more qubits, where the first set of quantum operations can be executable to generate one or more quantum random numbers. The generating can further comprise applying, via a quantum random measurement component, a second set of quantum operations to the one or more qubits, where the second set of quantum operations can be conditional upon the one or more quantum random numbers.

Such embodiments of the system can provide a number of advantages, including reducing the number of quantum circuits and generating an efficiently executable dynamic quantum circuit that can be employed to make random selections as well as execute the random selections during quantum selections.

In one or more embodiments of the aforementioned system, the generating the dynamic quantum circuit can further comprise applying, via the quantum random number component, state preparation operations to qubits in the dynamic quantum circuit, where the state preparation operations can be executable to initialize the qubits into a desired quantum state prior to execution of the second set of quantum operations.

Such embodiments of the system can provide the advantage of generating an efficiently executable dynamic quantum circuit that can be employed to make random selections as well as execute the random selections. In certain cases, reset operations can be omitted and only state preparation operations can be applied, which can provide a further advantage of reducing the time consumed by reset operations in the quantum computations, since reset operations can involve slow and time consuming instructions.

In one or more embodiments, the aforementioned system can further comprise a quantum circuit execution component that can execute the dynamic quantum circuit on a quantum computer to generate expectation values for observables. Executing the dynamic quantum circuit can comprise executing the first set of quantum operations to generate the one or more quantum random numbers. Executing the dynamic quantum circuit can further comprise selectively executing the second set of quantum operations, based on the one or more quantum random numbers, to generate random measurements.

Such embodiments of the system can provide a number of advantages, including reducing the number of quantum circuits employed in quantum computations and in executing quantum algorithms, reducing execution time for quantum computations, and increasing the efficiency of execution of quantum circuits.

In one or more embodiments of the aforementioned system, the selectively executing the second set of quantum operations can increase an efficiency of execution of the dynamic quantum circuit by reducing a number of executions and reducing an execution time corresponding to the execution.

Such embodiments of the system can provide the advantage of effectively implementing quantum algorithms and computations.

In one or more embodiments of the aforementioned system, the executing the dynamic quantum circuit can further comprise repeating or executing in parallel the first set of quantum operations and the second set of quantum operations.

Such embodiments of the system can provide a number of advantages, including further reducing execution time for quantum computations, and increasing the efficiency of execution of quantum circuits.

In one or more embodiments of the aforementioned system, the executing the dynamic quantum circuit can further comprise repeating and executing in parallel the first set of quantum operations and the second set of quantum operations.

Such embodiments of the system can provide a number of advantages, including further reducing execution time for quantum computations, and increasing the efficiency of execution of quantum circuits.

In one or more embodiments of the aforementioned system, the one or more qubits can be qubits in a main register.

Such embodiments of the system can provide a number of advantages, including reducing the number of quantum circuits and generating an efficiently executable dynamic quantum circuit that can be employed to make random selections as well as execute the random selections.

In one or more embodiments of the aforementioned system, the one or more qubits can be auxiliary qubits.

Such embodiments of the system can provide the advantage of improving the coherence time for qubits via as-late-as possible (ALAP) scheduling, where the first set of quantum gates can be applied closer in time to the second set of quantum gates.

In one or more embodiments of the aforementioned system, the one or more quantum random numbers can be generated based on prior measurements and a neural network.

Such embodiments of the system can provide the advantage of implementing decision diagrams or Bayesian networks in conjunction with the dynamic quantum circuit.

An embodiment in which the quantum circuit generation component can generate a dynamic quantum circuit by applying at least the first set of quantum operations and the second set of quantum operations to the one or more qubits, where the second set of quantum operations can be conditional upon the one or more quantum random numbers that can be generated by execution of the first set of quantum operations, and in which the one or more qubits can be auxiliary qubits, can provide a number of advantages including reducing the number of quantum circuits employed in quantum computations associated with the dynamic quantum circuit, reducing execution time for the quantum computations, increasing the efficiency of execution of the dynamic quantum circuit, and improving the coherence time for qubits via ALAP scheduling, where the first set of quantum gates can be applied closer in time to the second set of quantum gates.

An embodiment in which the quantum circuit generation component can generate a dynamic quantum circuit by applying at least the first set of quantum operations and the second set of quantum operations to the one or more qubits, where the second set of quantum operations can be conditional upon the one or more quantum random numbers that can be generated by execution of the first set of quantum operations, the one or more qubits can be auxiliary qubits, and executing the dynamic quantum circuit can comprise repeating and/or executing in parallel the first set of quantum operations and the second set of quantum operations can provide a number of advantages including reducing the number of quantum circuits employed in quantum computations associated with the dynamic quantum circuit, reducing execution time for the quantum computations, and increasing the efficiency of execution of the dynamic quantum circuit.

In various embodiments, the above-described system can be employed for random selection in quantum computations. For example, the above-described system can be employed to execute quantum algorithms including, but not limited to, classical shadow, Twirled Readout Error extinction (TREX), Pauli twirling, probabilistic error cancellation (PEC) and probabilistic error amplification, while reducing the number of quantum circuits typically employed for execution of such quantum algorithms. For example, quantum algorithms such as the classical shadow algorithm, can be executable with only one dynamic quantum circuit instead of 3ⁿ types of quantum circuits, thereby significantly reducing the execution time of the corresponding quantum computations.

According to various embodiments, the above-described system can be implemented as a computer-implemented method or as a computer program product.

### Definitions

Dynamic quantum circuit: A quantum circuit that can dynamically change or execute operations selectively based on results of prior measurements in the circuit. Dynamic quantum circuits can allow programmers to write codes to run different quantum circuits. For example, programmers can employ the same code to run different quantum circuits by utilizing if-else (conditional control) operations. Dynamic quantum circuits can be challenging to implement, and currently, only a few quantum devices (like the latest version of IBM® quantum devices) have the ability to execute dynamic circuits.

Quantum random number: A random number, i.e., a bitstring, that can be generated by measuring the outputs of quantum circuits. Stated differently, a quantum random number can be generated by execution of a quantum circuit/quantum operations.

Hamiltonian: A Hamiltonian represents a problem to be solved (e.g., combinatorial optimization problem, etc.) on a quantum computer. The Hamiltonian for a problem can be independent from a quantum circuit corresponding to the problem in that a Hamiltonian describes the part of a quantum circuit that is to be evaluated. For example, to evaluate a molecule, the same quantum circuit with different Hamiltonians can be employed.

X, Y and Z measurement bases: In quantum computing, the X, Y and Z measurement bases respectively correspond to different axis of a Bloch sphere, wherein the Bloch sphere represents the different states of a qubit. In this regard, measurements in the X, Y, or Z measurement bases refer to measuring the state of a qubit along different axes of the Bloch sphere.

A quantum device (e.g., quantum computing system, quantum computer, etc.) without the ability to execute dynamic quantum circuits can only run one type of quantum circuit at a time and repeat the executions/shots multiple time (e.g., execute 1,024 shots, 10,000 shots, etc.). Such quantum devices can be applicable to increase the estimation accuracy of a quantum circuit, wherein quantum circuit executions can be repeated several times followed by computing an average expectation value based on the resultant outcomes, since the average expectation value can be expected to converge to the true value for an observable by the law of large numbers. However, newly proposed quantum computing methods to obtain higher measurement accuracies in quantum chemistry and optimization experiments involve slightly changing the measurement bases of quantum circuits. The number of possible measurement bases can grow exponentially based on the number of qubits (e.g., 3″ measurement bases for n qubits) which can result in 3″ number of different quantum circuits to execute the experiments on quantum devices that do not have the capability to execute dynamic quantum circuits. Thus, techniques to reduce the number of quantum circuits involved in quantum computations while accounting for various possible combinations of measurement bases can be desirable.

Various embodiments of the present disclosure can be implemented to produce a solution to these problems. Embodiments described herein include systems, computer-implemented methods, and computer program products that can employ quantum random numbers with dynamic quantum circuits to reduce the number of quantum circuits to be executed on a quantum computer. Such embodiments can be employed to execute random quantum algorithms and other quantum computations. As a result, quantum algorithms can be executable with only one type of quantum circuit instead of, for example, 3″ types of quantum circuits, thereby significantly reducing the execution time of the corresponding quantum computations. For example, one or more embodiments herein can generate a dynamic quantum circuit by inserting quantum gate sequences and quantum operations based on quantum random numbers, wherein the quantum random numbers can be generated by employing auxiliary qubits or system qubits (i.e., qubits in the main register) followed by implementing resets, prior to running the main quantum circuit comprising the quantum gate sequences and quantum operations.

More specifically, a quantum circuit generation component can employ a quantum random number component to apply a first set of quantum operations to one or more qubits, wherein the first set of quantum algorithms can be selected based on a probability distribution for measurement bases. The random quantum number component can also apply reset operations and state preparation operations to qubits in the dynamic quantum circuit. The reset operations can be executable to reset the qubits after generating the quantum random numbers and the state preparation operations can be executable to generate a desired quantum state for the qubits prior to execution of the dynamic quantum circuit. In certain implementations, the reset operations can be omitted and only state preparation operations can be applied by random quantum number component. The quantum circuit generation component can additionally employ a quantum random measurement component that can apply a second set of quantum operations to the one or more qubits and/or additional qubits in the dynamic quantum circuit, wherein the second set of quantum operations can be conditional upon the quantum random numbers that can be generated. Upon generation of the dynamic quantum circuit, a quantum circuit execution component can execute the dynamic quantum circuit on a quantum computer or on a classical computer via a classical simulator of a quantum computer. During the execution, the second set of quantum operations can be selectively executed based on the quantum random numbers generated. Such a dynamic quantum circuit can be employed to make random selections of quantum circuits and execute the random selections to generate expectation values for observables that can otherwise involve exponential numbers of quantum circuits that can be infeasible to practically execute on quantum computers or classical simulators of quantum computers.

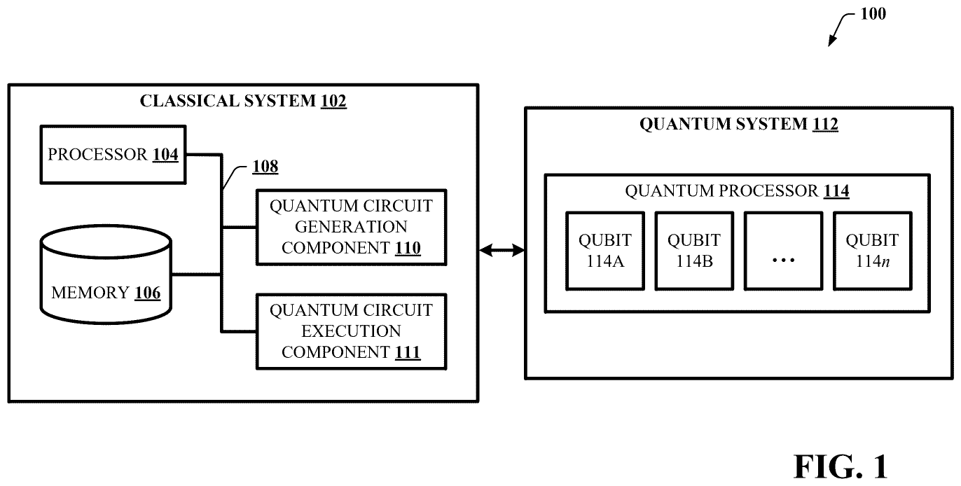

The embodiments depicted in one or more figures described herein are for illustration only, and as such, the architecture of embodiments is not limited to the systems, devices and/or components depicted therein, nor to any particular order, connection and/or coupling of systems, devices and/or components depicted therein. For example, in one or more embodiments, the non-limiting systems described herein, such as non-limiting system 100 as illustrated at FIG. 1, and/or systems thereof, can further comprise, be associated with and/or be coupled to one or more computer and/or computing-based elements described herein with reference to an operating environment, such as the operating environment 1400 illustrated at FIG. 14. For example, non-limiting system 100 can be associated with, such as accessible via, a computing environment 1400 described below with reference to FIG. 14, such that aspects of processing can be distributed between non-limiting system 100 and the computing environment 1400. In one or more described embodiments, computer and/or computing-based elements can be used in connection with implementing one or more of the systems, devices, components and/or computer-implemented operations shown and/or described in connection with FIG. 1 and/or with other figures described herein.

In the one or more figures illustrating quantum circuits, quantum gates have been identified by patterned squares wherein like patterns have been employed to identify like gates throughout the figures, unless a legend indicates otherwise. Additionally, the various quantum operations in the figures have been identified by well-known symbols commonly employed in quantum computing.

FIG. 1 illustrates a block diagram of an example, non-limiting system 100 that can generate and execute dynamic quantum circuits with quantum random numbers in accordance with one or more embodiments described herein.

Non-limiting system 100 and/or the components of non-limiting system 100 can be employed to use hardware and/or software to solve problems that are highly technical in nature (e.g., related to quantum random numbers, dynamic quantum circuits, quantum algorithms, etc.), that are not abstract and that cannot be performed as a set of mental acts by a human. Further, some of the processes performed may be performed by specialized computers for carrying out defined tasks related to implementing quantum random numbers via dynamic quantum circuits. Non-limiting system 100 and/or components of non-limiting system 100 can be employed to solve new problems that arise through advancements in technologies mentioned above, computer architecture, and/or the like. Non-limiting system 100 can provide technical improvements to quantum computing systems by reducing the number of quantum circuits employed in quantum computations and in executing quantum algorithms, reducing execution time for quantum computations, increasing the efficiency of execution of quantum circuits, etc.

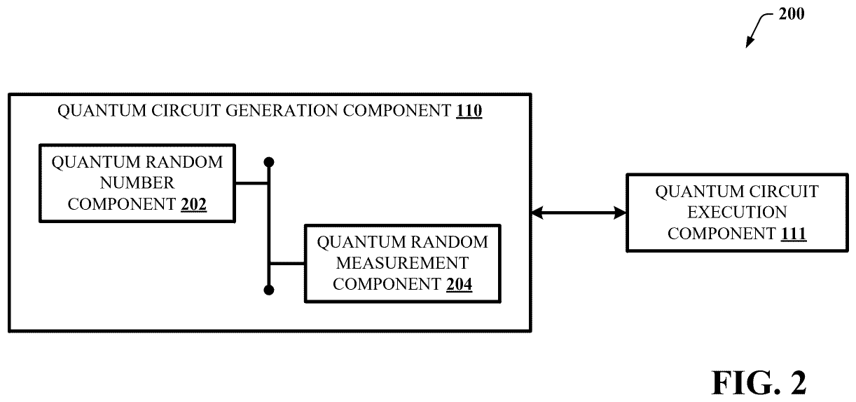

As illustrated in FIG. 1, non-limiting system 100 can comprise classical system 102 and quantum system 112. Classical system 102 can be coupled (operatively, communicatively, electrically, and/or like function) to quantum system 112. Quantum system 112 can comprise at least one quantum processor, such as quantum processor 114. Classical system 102 can comprise one or more components, such as a memory 106, processor 104, bus 108, quantum circuit generation component 110 and/or quantum circuit execution component 111. As illustrated in FIG. 2, quantum circuit generation component 110 can further comprise quantum random number component 202 and/or quantum random measurement component 204. In an embodiment, quantum circuit generation component 110 and/or quantum circuit execution component 111 can be comprised at least partially in quantum system 112. Quantum processor 114 can comprise a quantum logic circuit comprising one or more qubits, such as qubit 114A, qubit 114B, . . . , qubit 114n, etc., where n represents a positive integer. Quantum processor 114 can be any suitable processor. Quantum processor 114 can generate one or more instructions for controlling the quantum logic circuit.

Discussion turns briefly to processor 104, memory 106 and bus 108 of non-limiting system 100. For example, in one or more embodiments, non-limiting system 100 can comprise processor 104 (e.g., computer processing unit, microprocessor, classical processor, and/or like processor). In one or more embodiments, a component associated with non-limiting system 100, as described herein with or without reference to the one or more figures of the one or more embodiments, can comprise one or more computer and/or machine readable, writable and/or executable components and/or instructions that can be executed by processor 104 to enable performance of one or more processes defined by such component(s) and/or instruction(s).

In one or more embodiments, non-limiting system 100 can comprise a computer-readable memory (e.g., memory 106) that can be operably connected to processor 104. Memory 106 can store computer-executable instructions that, upon execution by processor 104, can cause processor 104 and/or one or more other components of non-limiting system 100 (e.g., quantum circuit generation component 110 and/or quantum circuit execution component 111) to perform one or more actions. In one or more embodiments, memory 106 can store computer-executable components (e.g., quantum circuit generation component 110 and/or quantum circuit execution component 111).

Non-limiting system 100 and/or a component thereof as described herein, can be communicatively, electrically, operatively, optically and/or otherwise coupled to one another via bus 108. Bus 108 can comprise one or more of a memory bus, memory controller, peripheral bus, external bus, local bus, and/or another type of bus that can employ one or more bus architectures. One or more of these examples of bus 108 can be employed. In one or more embodiments, non-limiting system 100 can be coupled (e.g., communicatively, electrically, operatively, optically and/or like function) to one or more external systems (e.g., a non-illustrated electrical output production system, one or more output targets, an output target controller and/or the like), sources and/or devices (e.g., classical computing devices, communication devices and/or like devices), such as via a network. In one or more embodiments, one or more of the components of non-limiting system 100 can reside in the cloud, and/or can reside locally in a local computing environment (e.g., at a specified location(s)).

The components comprised in non-limiting system 100 can represent one or more computer and/or machine readable, writable and/or executable components and/or instructions that, when executed by processor 104, can enable performance of one or more operations defined by such component(s) and/or instruction(s). For example, in one or more embodiments, quantum circuit generation component 110 can generate a dynamic quantum circuit that can be employed to implement random quantum algorithms. To generate the dynamic quantum circuit, quantum circuit generation component 110 can apply, via quantum random number component 202, a first set of quantum operations to one or more qubits, wherein the first set of quantum operations can be executable to generate one or more quantum random numbers. Additionally, quantum circuit generation component 110 can apply to the one or more qubits and/or to additional/different qubits in the dynamic quantum circuit, a second set of quantum operations that are conditional upon the one or more quantum random numbers. The first set of quantum operations can comprise random quantum gates selected by quantum random number component 202 to generate the one or more quantum random numbers. The second set of quantum operations can comprise conditional control operations that are adaptively selected by quantum random measurement component 204 to generate random measurements based on the one or more quantum random numbers.

Quantum random number component 202 can select the first set of quantum operations based on a probability distribution across X, Y and/or Z measurement bases. For example, quantum random number component 202 can select the first set of quantum operations based on an equal probability distribution of measuring a qubit in the X measurement basis, Y measurement basis and the Z measurement basis, and the operations selected by quantum random number component 202 can comprise random quantum gates. In quantum computing, the X, Y and Z measurement bases respectively correspond to different axis of a Bloch sphere, wherein the Bloch sphere represents the different states of a qubit. In this regard, measurements in the X, Y, or Z measurement bases refer to measuring the state of a qubit along different axes of the Bloch sphere. Individual quantum operations comprised in the first set of quantum operations selected by quantum random number component 202 can be applied to a single qubit or to multiple qubits. Additionally, the first set of quantum operations can be applied to one or more system qubits (i.e., qubits in the main register) or to one or more ancilla qubits.

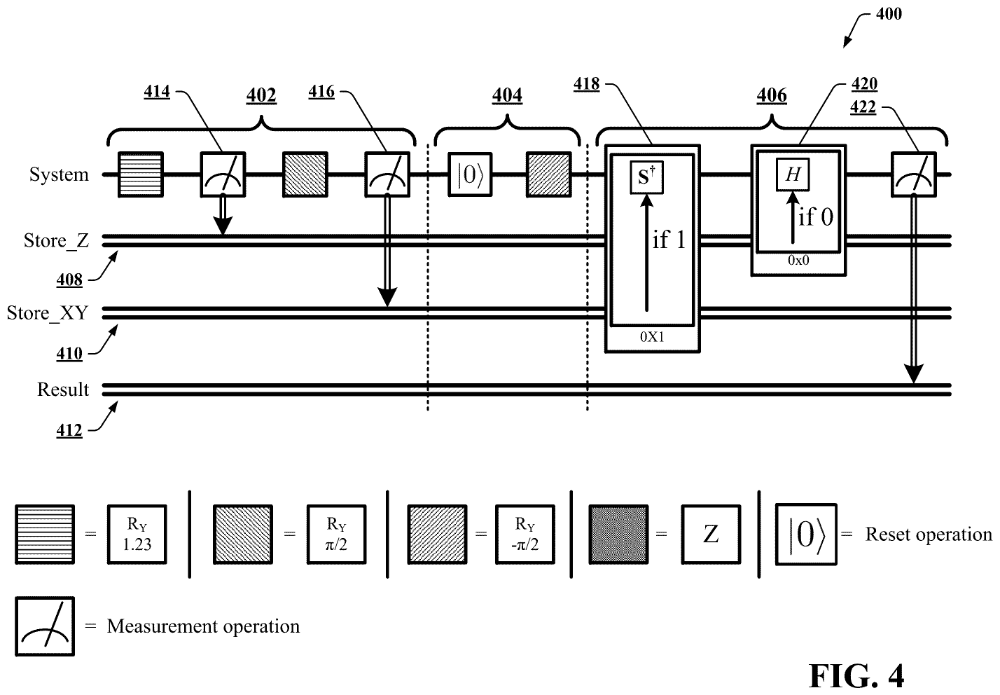

Turning briefly to FIG. 4, non-limiting dynamic quantum circuit 400 can be an exemplary dynamic quantum circuit that can be generated by quantum circuit generation component 110. The quantum operations in block 402 can represent the first set of quantum operations that can selected by quantum random number component 202 and that can be executable to generate one or more quantum random numbers. Quantum random number component 202 can select the rotational gates and gate angles (e.g., Ry 1.23, Ry π/2, Ry-π/2, etc.) based on an equal probability distribution of measuring a qubit in the X measurement basis, Y measurement basis and the Z measurement basis. An Ry gate is a rotational gate that represents a single qubit rotation of angle θ radians (e.g., θ=−π radians, π/2 radians, etc.) around the Y-axis of the Bloch sphere. Similarly, the R_{z} gate is a rotational gate that represents a single qubit rotation of angle θ radians (e.g., θ=−π radians, π/2 radians, etc.) around the Z-axis of the Bloch sphere, and the Rₓ gate is a rotational gate that represents a single qubit rotation of angle θ radians (e.g., θ=−π radians, π/2 radians, etc.) around the X-axis of the Bloch sphere. Although the first set of quantum operations are illustrated as being applied to a single system qubit in non-limiting dynamic quantum circuit 400, in other examples, the first set of quantum operations can be applied to multiple system qubits or one or more ancilla qubits. In FIG. 4, block 402 illustrates random quantum gates; however, the various embodiments herein are not limited to random measurements.

In one or more embodiments, to generate the dynamic quantum circuit, quantum circuit generation component 110 can further apply, via quantum random number component 202, reset operations to the one or more qubits and/or to additional/different qubits in the dynamic quantum circuit, wherein the reset operations can be executable to reset the one or more qubits and/or the additional/different qubits corresponding to the first set of quantum operations. In an embodiment, quantum circuit generation component 110 can insert the reset operations in the dynamic quantum circuit after the first set of quantum operations. In another embodiment, reset operations can be eliminated and not applied. By applying the reset operations after the first set of quantum operations as opposed to applying the reset operations as part of the first set of quantum operations or by not applying reset operations altogether, the quantum random number generation can be expedited. That is, the one or more quantum random numbers can be generated faster if the qubits are not reset during generation of the one or more quantum random numbers. This is because reset operations and instructions can be slow and time consuming.

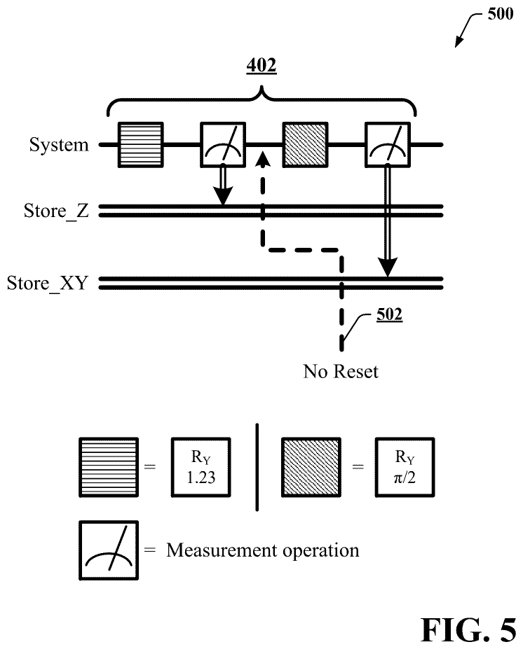

For example, with reference FIGS. 4 and 5, a reset gate can be typically applied after the first measurement operation, at 502, in block 402. However, in various embodiments herein, such reset gates can be eliminated from the first set of quantum operations to speed up generation of the one or more quantum random numbers and because the generated probability distribution is the same in either case. Quantum circuit generation component 110 can further apply, via quantum random number component 202, state preparation operations to qubits in the dynamic quantum system, wherein the state preparation operations can be executable to initialize the qubits into a desired quantum state prior to execution of the second set of quantum operations. In non-limiting dynamic quantum circuit 400, block 404 represents the reset operations and the state preparation operations. Unlike the random measurements that can be generated by selective application of the second set of quantum operations, the reset and state preparation operations can be fixed operations that can be independent of the quantum random numbers that can be generated.

In one or more embodiments, when the one or more quantum random numbers are generated from an auxiliary system, for example, by applying (e.g., via quantum random number component 202) the first set of quantum operations to auxiliary qubits, the coherence time for qubits can be improved by ALAP scheduling. ALAP scheduling can refer to applying the first set of quantum gates that can generate the one or more quantum random numbers closer to the second set of quantum gates. In other words, the timing for random number generation in the dynamic quantum circuit can be adjusted. For example, the state preparation circuit can be a large circuit, and the random number generation can be closer to the random measurement generation.

In one or more embodiments, after generation of the dynamic quantum circuit by quantum circuit generation component 110, quantum circuit execution component 111 can execute the dynamic quantum circuit on a quantum computer (e.g., quantum system 112) or on a classical computer (e.g., classical system 102) via a classical simulator of a quantum computer to generate expectation values for observables. During execution of the dynamic quantum circuit on the quantum computer, the first set of quantum operations can first be executed to generate the one or more quantum random numbers, and the second set of quantum operations can be selectively executed based on the one or more quantum random numbers to generate random measurements. For example, quantum circuit execution component 111 can execute the first set of quantum operations to generate measurements (i.e., quantum random numbers) that can be output to classical registers. Based on the measurements, quantum circuit execution component 111 can selectively execute the quantum operations comprised in the second set of quantum operations.

For example, in non-limiting dynamic quantum circuit 400 illustrated in FIG. 4, registers 408, 410 and 412 can represent classical registers. Register 408 can store measurements corresponding to the Z measurement basis (“store_Z”) which can indicate to quantum circuit execution component 111 whether a Z measurement basis is to be employed to generate the expectation values based on the second set of quantum operations. Similarly, register 410 can store measurements corresponding to the X and Y measurement bases (“store_XY”) which can indicate to quantum circuit execution component 111 whether the X measurement basis or the Y measurement basis is to be employed to generate the expectation values based on the second set of quantum operations. If the measurement operation at 414 outputs a value of zero (0) for register 408, then a Hadamard (H) gate can be applied at 420, and if the measurement operation at 416 outputs a value of one (1) for register 410, then the S^{†} gate can be applied at 418. The Hermitian conjugate symbol, “†”, indicates that the S^{†} gate is a conjugate transpose of the S quantum gate. In another example, a qubit can be initialized, and Pauli twirling (or another quantum operation) can be performed on the qubit based on an outcome of a first quantum random number. Twirling can involve random gate insertion into quantum circuits. Additionally, a Hadamard gate can be applied on the qubit based on an outcome of a second quantum random number. Finally, the qubit can be measured. Thus, in one or more embodiments, quantum random numbers can be employed in quantum algorithms via dynamic quantum circuits. Quantum random numbers can enable faster execution of quantum algorithms. Additionally, a small number of dynamic quantum circuits can consume less execution time and are therefore more computationally efficient than a large number of static quantum circuits.

Selectively applying the second set of quantum operations can increase an efficiency of execution of the dynamic quantum circuit by reducing a number of executions and reducing an execution time corresponding to the execution. In an implementation, executing the dynamic quantum circuit can comprise repeating or executing in parallel the first set of quantum operations and the second set of quantum operations. That is, the first set of quantum operations and the second set of quantum operations can be repeatedly executed or executed in parallel. In another implementation, executing the dynamic quantum circuit can comprise repeating and executing in parallel the first set of quantum operations and the second set of quantum operations. That is, the first set of quantum operations and the second set of quantum operations can be repeatedly executed or executed in parallel.

In one or more embodiments, the one or more quantum random numbers based on the first set of quantum operations can be generated based on prior measurements generated via a neural network. For example, to achieve a better estimation for the expectation values of observables via execution of the dynamic quantum circuit, the one or more quantum random numbers can be made biased and/or made conditional upon prior measurements generated via with a decision diagram or a Bayesian network. For example, depending upon the output of the execution of the first set of quantum operations and a neural network, a selection of the second set of quantum operations can be determined.

FIG. 2 illustrates a block diagram of an example, non-limiting system 200 that can generate and execute dynamic quantum circuits with quantum random numbers in accordance with one or more embodiments described herein. Repetitive description of like elements and/or processes employed in respective embodiments is omitted for sake of brevity.

Non-limiting system 200 illustrates the system of quantum circuit generation component 110 and quantum circuit execution component 111. As discussed with reference to FIG. 1, quantum circuit generation component 110 can comprise quantum random number component 202 and quantum random measurement component 204.

In one or more embodiments, quantum random number component 202 can select a first set of quantum operations comprising random quantum operations, based on an equal (or unequal) probability distribution of the X, Y and Z measurement bases. Quantum random number component 202 can apply the first set of quantum operations at the beginning of a dynamic quantum circuit. In some embodiments, quantum random number component 202 can additionally apply reset operations and state preparation operations in the dynamic quantum circuit after the first set of quantum operations. In other embodiments, quantum random number component 202 can apply the reset operations and the state preparation operations in a different order. In yet other embodiments, quantum random number component 202 can apply only the state preparation operations without applying the reset operations.

In one or more embodiments, quantum random measurement component 204 can apply a second set of quantum operations that can be conditional upon the one or more quantum random numbers. For example, the second set of quantum operations can comprise conditional control operations such as if-else operations. As a result, in various embodiments herein, a single dynamic quantum circuit can be employed to generate measurements in X, Y and/or Z measurement bases, as opposed to employing individual quantum circuits to generate measurements in the respective X, Y and Z measurement bases.

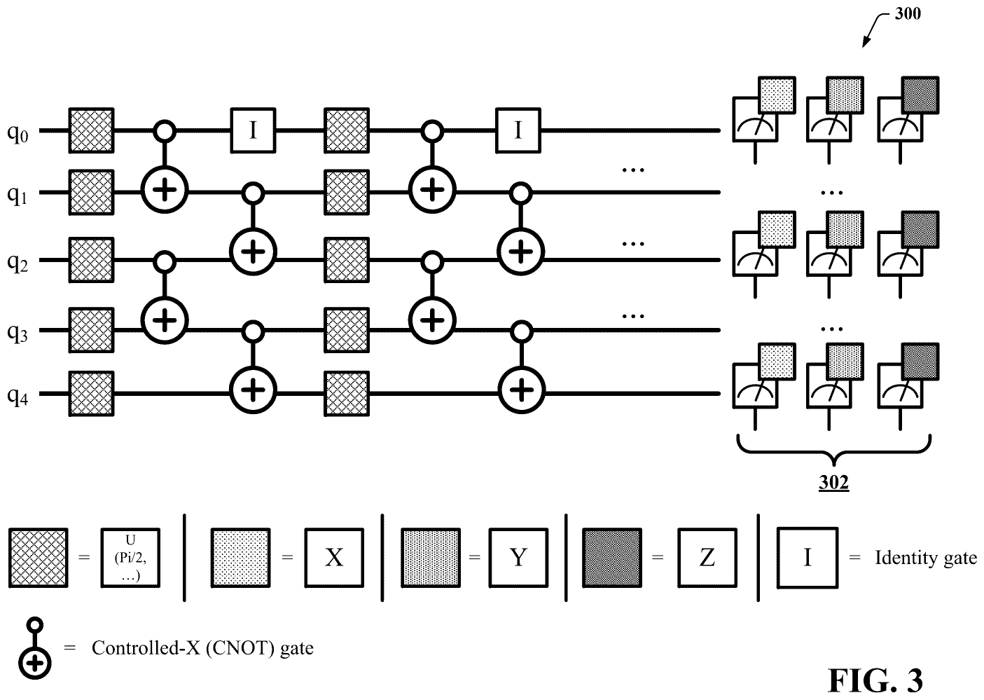

Embodiments of the present disclosure can be employed to efficiently make random choices in experiments. For example, the various embodiments herein can employ dynamic quantum circuits to reduce the number of quantum circuits that are typically executed as part of quantum computing tasks involving executions of random quantum circuits. For example, certain quantum computing tasks can involve the execution of large numbers of different types of quantum circuits, as discussed with reference to FIG. 3. However, executing all quantum circuits can be practically challenging to accomplish due to the amount of computational resources that can be consumed in the process. For such quantum computing tasks, the quantum circuits to be executed are often randomly selected and executed. In one or more embodiments, the various embodiments herein can enable such random selection via a single dynamic quantum circuit. It should be noted that quantum computers cannot employ classical random numbers and therefore, the various embodiments herein employ quantum random numbers.

FIG. 3 illustrates a schematic of an example, non-limiting quantum circuit 300 that can be employed to execute quantum algorithms. Repetitive description of like elements and/or processes employed in respective embodiments is omitted for sake of brevity.

Several quantum algorithms can employ random numbers. Some examples of such quantum algorithms include classical shadow, TREX, Pauli twirling, PEC and probabilistic error amplification. However, many quantum computers do not support random number generation, and existing quantum computing methods that utilize such quantum computers to execute quantum algorithms are typically employed via slightly different variations of quantum circuits that can be executed with 1 shot (shots=1). The classical shadow algorithm is an example of such a quantum algorithm. Such quantum computing methods can be inefficient because they can involve the writing/designing of many quantum circuits by an entity (e.g., hardware, software, neural network, artificial intelligence (AI), machine and/or user). Additionally, running multiple quantum circuits on quantum computers can involve a significant execution time due to the setup time, etc. consumed in the process.

For example, non-limiting quantum circuit 300 can be a quantum circuit with n qubits, and non-limiting quantum circuit 300 can be executed without the support of random numbers. The resultant quantum state of a quantum circuit with n qubits can be identified by measuring in {X, Y, Z}”ⁿ measurement bases. Stated differently, identifying the quantum state of a quantum circuit with n qubits can involve 3ⁿ measurement bases. However, each measurement can correspond to an individual quantum circuit. For example, as illustrated at 302, 3ⁿ types of shallow measurements, each based on a slightly different gate setup prior to measurement on quantum devices, can be employed to execute non-limiting quantum circuit 300 without the use of random numbers to generate measurements in the X, Y and Z measurement bases. Thus, identifying the resultant quantum state of the quantum circuit with n qubits can involve 3ⁿ quantum circuits. On the contrary, the various embodiments herein can generate quantum measurements more efficiently in the X, Y and Z measurement bases, as further explained with reference to FIG. 4.

FIG. 4 illustrates a schematic of an example, non-limiting dynamic quantum circuit 400 that can be executed to generate quantum random numbers and selectively execute quantum operations based on the quantum numbers in accordance with one or more embodiments described herein. Repetitive description of like elements and/or processes employed in respective embodiments is omitted for sake of brevity.

With continued reference to the embodiments disclosed with reference to FIG. 1, non-limiting dynamic quantum circuit 400 can represent the dynamic quantum circuit that can be generated by quantum circuit generation component 110. For example, quantum random number component 202 can select the first set of quantum operations illustrated at block 402 based on a probability distribution of X, Y and/or Z measurement bases applicable to a problem to be solved. Quantum random number component 202 can apply the first set of quantum operations to the system qubit, and the first set of quantum operations can be executable to generate quantum random numbers. Registers 408, 410 and 412 can represent classical registers, and the one or more quantum random numbers generated by execution of the first set of quantum operations can be output to register 408 and register 410. Quantum random number component 202 can additionally apply reset operations and state preparation operations to the one or more qubits, as illustrated at block 404. In some implementations, quantum random number component 202 can apply only the state preparation operations to the one or more qubits without applying reset operations.

After application of the reset operations and/or the state preparation operations, quantum random measurement component 204 can apply the second set of quantum operations illustrated at block 406 to the system qubit. The second set of quantum operations can comprise conditional operations. Upon execution of non-limiting dynamic quantum circuit 400 by quantum circuit execution component 111 on a quantum system, the quantum operations comprised in the second set of quantum operations can be selective executed. For example, if the measurement operation at 414 outputs a value of zero (0) for register 408, then an H gate can be executed at 420, and if the measurement operation at 416 outputs a value of one (1) for register 410, then the S^{†} gate can be executed at 418. If the S^{†} gate is executed, the measurement becomes a measurement in the Y measurement basis, if the S^{†} gate is not executed, the measurement becomes a measurement in the Z measurement basis, and if the H gate is executed, the measurement becomes measurement in the X measurement basis. The H and S^{†} gates are pre-rotation gates, i.e., gates that are executed prior to a measurement operation, such as that illustrated at 422.

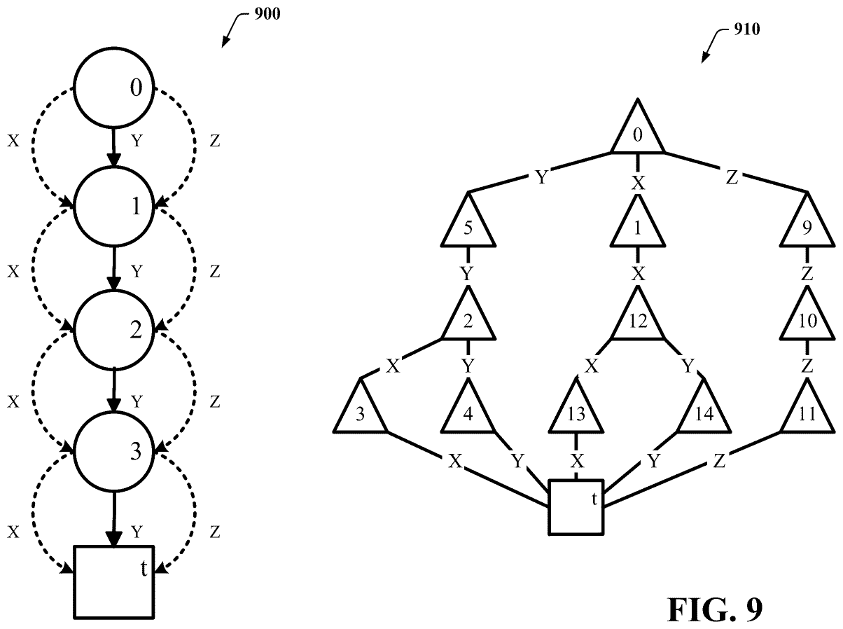

As discussed with reference to FIG. 3, existing techniques can employ different respective quantum circuits to measure qubits in the X, Y, and Z measurement bases. On the contrary, in one or more embodiments herein, quantum random numbers can be employed to randomly select X, Y and/or Z basis measurements by executing only one dynamic quantum circuit. As a result, random measurements such as those involved in the classical shadow algorithm can be performed by changing the measurement basis based on the quantum random number generated via execution of the dynamic quantum circuit, and quantum operations such as Pauli twirling (Pauli twirling and measurement symmetrization) and probabilistic error cancellation/amplification can be performed with quantum random numbers. Additional exemplary applications for embodiments of the present disclosure are disclosed with reference to at least FIG. 9.

FIG. 5 illustrates a schematic of an example, non-limiting quantum circuit 500 that can be executed to generate quantum random numbers in accordance with one or more embodiments described herein. Repetitive description of like elements and/or processes employed in respective embodiments is omitted for sake of brevity.

With continued reference to FIGS. 1, 2 and 4, non-limiting quantum circuit 500 illustrates block 402 of non-limiting dynamic quantum circuit 400. As stated elsewhere herein, quantum random number component 202 can apply reset operations to the one or more qubits after applying the first set of quantum operations. In some implementation, the reset operations can be eliminated altogether. Reset operations can be slow and involve time consuming instructions. Thus, applying reset operations intermediately, for example, at 502, can slow the process of quantum random number generation, thereby slowing the efficiency of execution of the dynamic quantum circuit.

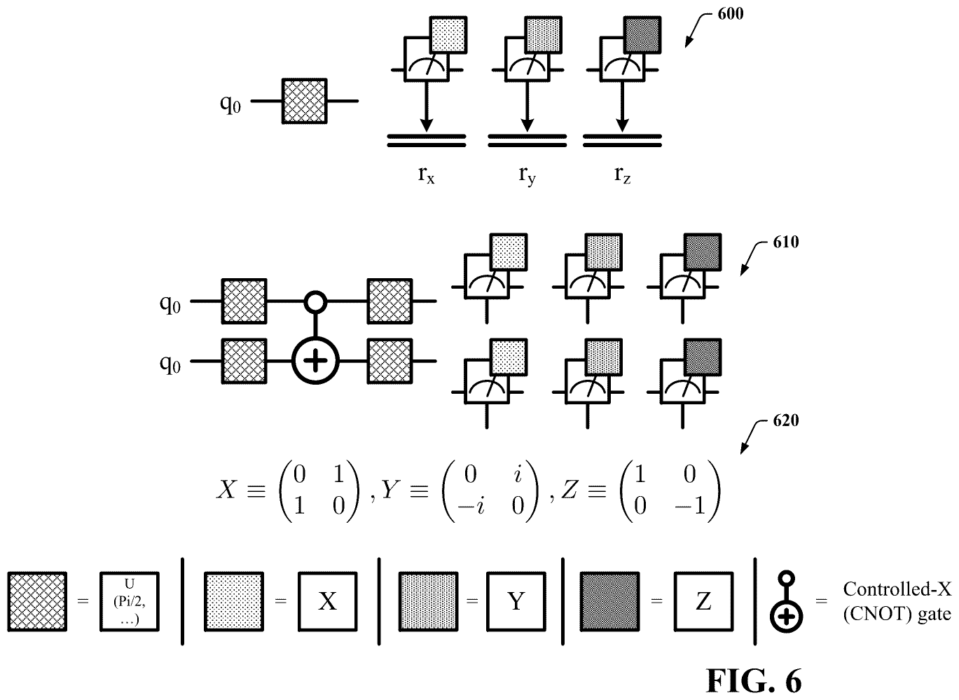

FIGS. 6, 7 and 8 are intended to highlight some of the disadvantages of existing quantum computing techniques and well as the advantages of the various embodiments disclosed herein.

FIG. 6 illustrates schematics of example, non-limiting quantum circuits 600 and 610 that can be employed to execute quantum algorithms. Repetitive description of like elements and/or processes employed in respective embodiments is omitted for sake of brevity.

As discussed with reference to FIG. 3, the resultant quantum state of a quantum circuit with n qubits can be identified by measuring in {X, Y, Z}ⁿ measurement bases. An example of vectors corresponding to the X, Y, Z measurement bases is illustrated at 620. Although n-qubit quantum states can be employed to represent vectors of exponential (exp(n)/eⁿ) dimensions, extracting all the information from a quantum circuit can involve an exponential number of measurements. For example, non-limiting quantum circuit 600 illustrates a quantum circuit with one qubit. Non-limiting quantum circuit 600 can be represented by

$$\vert 0 〉 〈 0 \vert \to ρ ≡ U \vert 0 〉 〈 0 \vert {U}^{†} = \frac{1}{2} ( I + {r}_{X} X + {r}_{y} Y + {r}_{z} Z ) .$$

Identifying the resultant quantum state of non-limiting quantum circuit 600 can involve measurements in {X, Y, Z} measurement bases with three quantum circuits, one for each measurement basis. Similarly, non-limiting quantum circuit 610 illustrates a quantum circuit with two qubits. Non-limiting quantum circuit 610 can be represented by

$$\vert 0 〉 〈 0 \vert \to ρ = \frac{1}{4} {\sum }_{{σ}_{1} , {σ}_{2} ∈ \{ I , X , Y , Z \}} {r}_{1 , 2 ,} {σ}_{1} ⊗ {σ}_{2} .$$

Identifying the resultant quantum state of non-limiting quantum circuit 610 can involve measurements in {X, Y, Z}² measurement bases with nine quantum circuits, one for each measurement basis. Thus, an exponential number of quantum circuits can be generated for measuring the quantum state of a quantum circuit with n qubits for precise estimation of expectation values. In FIG. 6 and elsewhere, “I” represents an identity gate.

As stated elsewhere herein, in existing quantum computing techniques, several quantum circuits can typically be run with one shot (shots=1) per quantum circuit because of the static nature of quantum circuits. The number of shots is set to 1 because random measurements cannot be implemented with the same quantum circuits. In quantum computing, an expectation value can be typically generated by executing multiple quantum circuits (i.e., a large number of shots) for sampling. As compared to experimental results generated by simulating dynamic quantum circuits to demonstrate the power of one shot dynamic quantum circuits, wherein the experimental results were obtained via a decision diagram-based classical shadow algorithm by running several quantum circuits with one shot on real quantum devices, embodiments of the present disclosure can obtain similar results for the decision diagram-based classical shadow algorithm in a much shorter time frame by running a single dynamic quantum circuit based on quantum random numbers. For example, given the experimental conditions in Table 1, embodiments of the present disclosure significantly improve the total execution time. Decision diagram-based measurements can generate the most precise estimation (e.g., lowest root-mean-square error (RMSE)).

TABLE 1
Experimental conditions

Run 100,000 random circuits.
Total time includes queue waiting time.
Device: IBM ®_Kolkata

In the naïve method, in the real experiment, executing 100,000 random quantum circuits can be infeasible. Thus, the results of the experiments conducted in the context of the present disclosure were obtained via extrapolation wherein the outcome of a single experiment (i.e., one job with one shot executed 100 times) was multiplied by 100 followed by dividing the number with 1000. Due to the restrictions of the quantum computer, the quantum circuit was divided into many jobs. A comparison of the results generated by the naïve method versus the results generated by embodiments of the present disclosure based on the experimental conditions in Table 1 is described in Table 2.

TABLE 2
Experimental results

| | Execution time | Total time |
|---|---|---|
| Method | (seconds) | (seconds) |
| Naïve method | 543205 | 66780000 |
| Embodiments disclosed herein | 39 | 2580 |

Random quantum algorithms such as classical shadow are highly efficient and can improve total job execution time. Efficient estimation of expectation values of quantum observables can further improve the quality of a product (estimator primitives) and can be beneficial for efficient estimation beyond the experimental conditions listed in Table 1 (100×100 challenge).

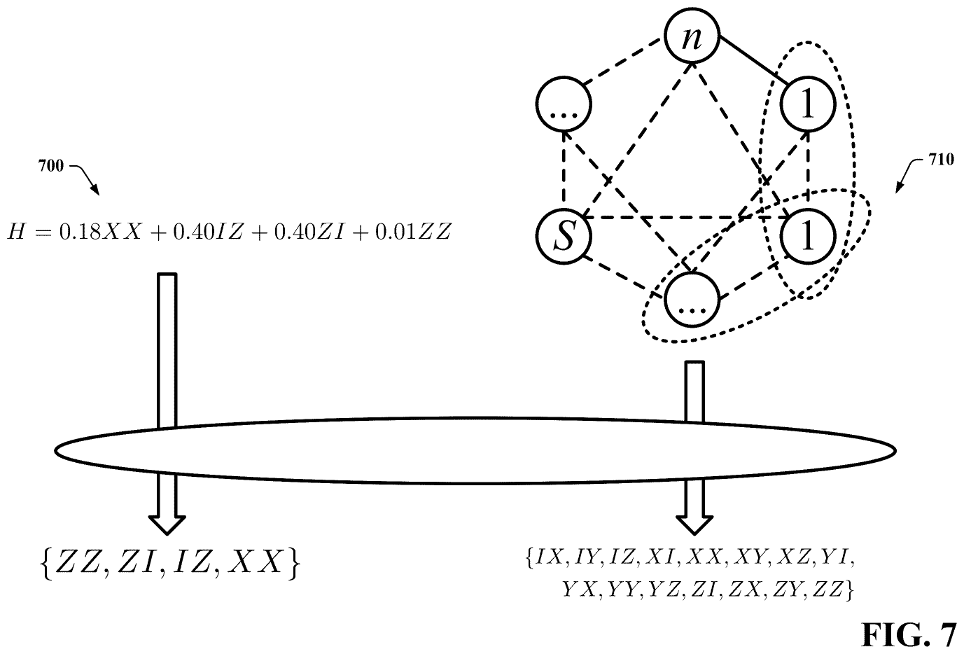

FIG. 7 illustrates example, non-limiting flow diagrams 700 and 710 that show the measurement bases applicable to different quantum computational problems in accordance with one or more embodiments herein. Repetitive description of like elements and/or processes employed in respective embodiments is omitted for sake of brevity.

Extracting relevant information from quantum states can involve quantum measurements in different measurement bases and in different combinations of measurement bases. In this regard, non-limiting flow diagram 700 can illustrate the measurement bases involved in computing the expectation values of a variational quantum circuit producing a quantum state ρ, according to Equations 1-4, and given the Hamiltonian H, according to Equation 2.

$${min}_{ϕ} 〈 ϕ \vert H \vert ϕ 〉 = {min}_{ρ} Tr ( H ρ ) \qquad Equation 1$$

$$H = 0.13 XX + 0.7 IZ + 0.7 ZI + 0.31 ZZ \qquad Equation 2$$

$$ρ = \frac{1}{4} ( I + ( {r}_{IX} + IX + {r}_{IY} IY + … + {r}_{ZZ} ZZ ) ) \qquad Equation 3$$

$$Tr ( H ρ ) = 0.13 {r}_{XX} + 0.7 {r}_{IZ} + 0.7 {r}_{ZI} + 0.31 {r}_{ZZ} \qquad Equation 4$$

Non-limiting flow diagram 710 illustrates an optimization problem that can be given by Equation 5.

$$ρ = \frac{1}{{2}^{n}} ( I + {\sum }_{i = 1}^{{4}^{n} - 1} {r}_{i} {σ}_{i} ⊗ … ⊗ {σ}_{n} ) \qquad Equation 5$$

As illustrated by non-limiting flow diagram 710, measuring all 2-qubit reduced density matrices of an n-qubit system can involve multiple pairs of measurement bases (e.g., IX, IY, IZ, . . . ) for any pair of qubits.

Thus, the chemistry-based application corresponding to non-limiting flow diagram 700 can involve only four combinations of measurement bases, whereas the optimization problem corresponding to non-limiting flow diagram 710 can involve several (many more than four) measurement bases. As such, the measurement bases employed in a quantum computing application can depend on the application itself.

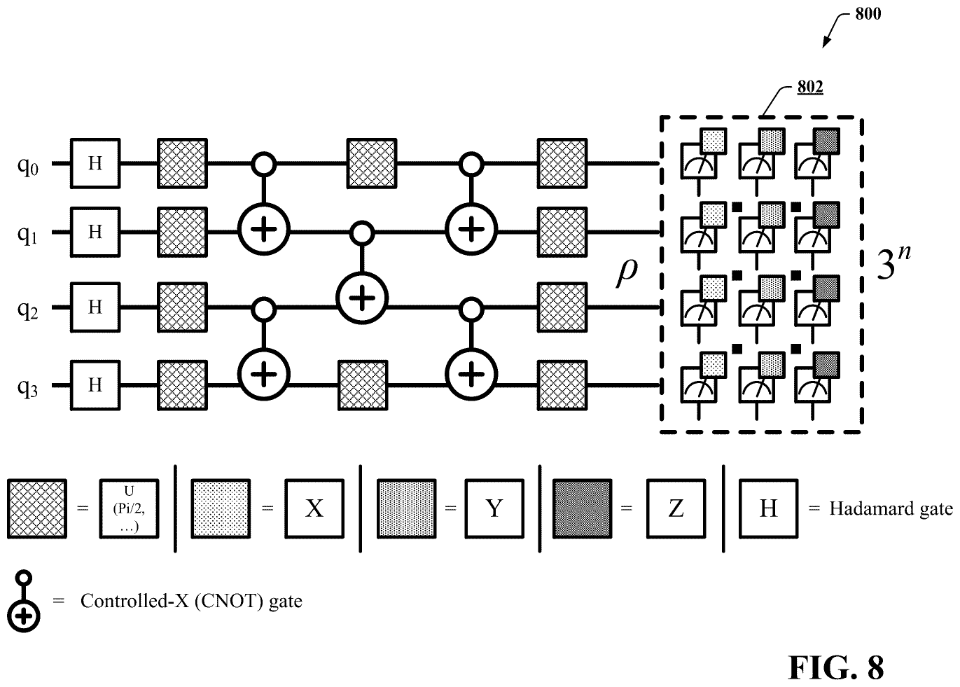

FIG. 8 illustrates a schematic of an example, non-limiting quantum circuit 800 in accordance with one or more embodiments described herein. Repetitive description of like elements and/or processes employed in respective embodiments is omitted for sake of brevity.

Continuing from the discussion with reference to FIG. 7, FIG. 8 is intended to describe precise estimation of quantum observables with shallow circuits (or shallow quantum circuits, shallow measurement circuits) and the corresponding results generated by various techniques. In FIG. 8, the X, Y and Z measurement bases are illustrated at 802.

Given an n-qubit Hamiltonian H, and non-limiting quantum circuit 800 prepared for a quantum state ρ, the entity Tr (Hρ) can be estimated with additive accuracy 0<ε<<1, wherein ρ represents a quantum state generated by state preparation quantum circuits (i.e., state preparation operations). In this regard, the Hamiltonian of Equation 6 can be solved to estimate a value (e.g., 10, 100, etc.) for Tr (H ρ) with accuracy, ε, wherein 0<ε<<1 (e.g., 0.01, 0.001, etc.). Equation 6 gives a 4-qubit Hamiltonian of Hydrogen (H₂) with Jordan-Wigner (JW) encoding.

$$H = - 0.81 IIII + 0.045 YYXX + 0.045 YYYY + 0.045 XXXX + 0.045 XXYY + 0.172 ZIII - 0.225 IZII + 0.172 IIZI - 0.225 IIIZ + 0.12 ZZII + 0.168 ZIZI + 0.166 ZIIZ + 0.166 IZZI + 0.174 IZIZ + 0.12 IIZZ \qquad Equation 6$$

The groups of measurement bases YYXX, ZZII, etc. can refer to Paulis that can define how non-limiting quantum circuit 800 can be measured. As evident from Equation 6, the number of Paulis in the Hamiltonian discussed herein is not significantly different from the number of qubits (n) in non-limiting quantum circuit 800 (e.g., number of Paulis is less than n² or n³). Yet, estimating Tr (Hp) according to the naïve method can involve performing measurements at every basis dictated by the Hamiltonian given by Equation 6, resulting in O(n⁴/ϵ²) number of measurements. However, the groups ZIII, IZII, IIZI, etc. can be measured simultaneously with the group ZZZZ (one type instead of ten types). Thus, the naïve method can be inefficient. Further in this regard, Equation 7 describes the number of Paulis associated with another Hamiltonian.

$$H = {\sum }_{P ∈ {\{ I , X , Y , Z \}}^{n}} {α}_{P} P \qquad Equation 7$$

The Hamiltonian of Equation 7 corresponds to an n degree polynomial (poly (n)) with about O(n⁴) number of α_{P}. A Hamiltonian can consist of many Paulis, for example, 100³, 1000⁶, etc. number of Paulis. In existing quantum computing techniques, such Paulis are measured randomly instead of measuring millions of Paulis. The selection of which Paulis to measure can be based on a selection criteria involving a source of randomness (e.g., similar to flipping coins) other than a quantum computer. On the contrary, embodiments of the present disclosure can assist with the selection of the different Paulis directly via a quantum device by employing qubits to generate quantum random numbers. As a result, in one or more embodiments, the selection of Paulis as well as estimation of expectation values based on the selected Paulis can be accomplished via a single dynamic quantum circuit. Table 3 lists a comparison of the number of measurements to be performed to estimate the entity Tr (Hρ) by employing different techniques for the quantum computational problem discussed herein.

TABLE 3

| | |
|---|---|
| Grouping method | Measured on grouped Tensor Product Basis (TPB) |
| | Classical Preprocessing: O(n⁸) |
| | Number of Measurements: O(n⁴/∈²) but has a better |
| | constant factor |
| Classical shadow method | Choose measurements uniformly at random |
| | Classical Preprocessing: O(1) |
| | Number of Measurements: O(n²/∈²) but only for k- |
| | local Hamiltonian |
| Locally Biased classical | Choose measurement with probability biased towards the |
| shadow method | Hamiltonian |
| (embodiments of the | Classical Preprocessing: O(n) |
| present disclosure) | Number of Measurements: O(n²/∈²) but with ~10x |
| | better constant factor |
| Decision Diagram classical | Choose “relevant” measurements biased towards the |
| shadow method | Hamiltonian |
| (embodiments of the | Classical Preprocessing: O(n⁵) |
| present disclosure) | Number of Measurements: O(n²/∈²) not only k-local |
| | but also with a better constant factor |

As evident from Table 3, embodiments of the present disclosure wherein quantum circuit generation component 110 can generate a dynamic quantum circuit that can generate quantum random numbers upon execution via quantum circuit execution component 111, and wherein based on the quantum random numbers, conditional gates can be executed to generate random measurements in the X, Y and/or Z measurements bases, can estimate results more efficiently and with a fewer number of measurements than the naïve method.

FIG. 9 illustrates example, non-limiting decision diagrams 900 and 910 in accordance with one or more embodiments described herein. FIG. 9 is intended for the explanation of decision diagrams in accordance with one or more embodiments described herein. Repetitive description of like elements and/or processes employed in respective embodiments is omitted for sake of brevity.

With continued reference to the Hamiltonian given by Equation 6, non-limiting decision diagram 900 represents a decision diagram that can be employed for the locally biased classical shadow algorithm and the classical shadow algorithm. Non-limiting decision diagram 900 can comprise O(n) nodes and O(n) edges. Similarly, non-limiting decision diagram 910 represents a decision diagram that can represent the Paulis covering/comprised in the Hamiltonian. For example, in non-limiting decision diagram 910, each path from the topmost triangle to the square at the bottom can generate strings, and all strings that appear on the paths of non-limiting decision diagram 910 can also appear in the Hamiltonian. Non-limiting decision diagram can comprise O(nm) nodes and O(nm) edges, wherein m can represent the number of Pauli terms. Either non-limiting decision diagram 900 or non-limiting decision diagram 910 can be employed to make random selections of Paulis for the same Hamiltonian. For example, all the Paulis in the Hamiltonian can be covered by the groups {YYXX, YYYY, XXXX, XXYY, ZZZZ} of measurement bases. For example, the group ZZZZ covers the groups ZIII, IZII, . . . IIZZ of measurement bases. Therefore, the Z measurement basis can be selected with a higher probability at locally-biased classical shadows (LBCS) based on non-limiting decision diagram 900. However, irrelevant measurements can sometimes be unavoidable. For example, the group YXXY is not relevant but can be chosen. Non-limiting decision diagram 910 can be more efficient because non-limiting decision diagram 900 comprises several extraneous paths. For example, non-limiting decision diagram 910 represents five paths, whereas non-limiting decision diagram 900 represents 3⁴ paths.

A decision diagram is a graphical representation of a decision-making process, and decision diagrams such as non-limiting decision diagrams 900 and 910 can be employed to randomly measure quantum circuits in the X, Y, or Z measurement basis. Decision diagrams can also be employed to generate a complex probability distribution. Given a Hamiltonian, a decision diagram for the Hamiltonian can be generated via certain procedures on a classical device. A decision diagram can identify how many of each measurement bases can be employed in a quantum computation based on the choices of measurement bases available. In one or more embodiments herein, the selection of the measurement bases from the available choices can be based on quantum random numbers. For example, a decision diagram can be generated via classical devices, whereas quantum devices can be employed to generate quantum random numbers and to generate a quantum state rule to randomly select the choices.

In quantum computing, decision diagrams are often employed for random selection. However, while existing techniques can generate decision diagrams or trees, such techniques do not provide any information on how to randomly select a path. For example, non-limiting decision diagram 910 can be selected to represent the Paulis in the Hamiltonian given by Equation 6, and based on non-limiting decision diagram 910, a source of randomness can be employed to randomly select the Paulis to be measured. In one or more embodiments, quantum circuit generation component 110 can generate a dynamic quantum circuit comprising a first set of quantum operations that can generate one or more quantum random numbers and further comprising a second set of quantum operations that can be conditional upon the quantum random numbers. Quantum circuit execution component 111 can select an appropriate decision diagram for the dynamic quantum circuit and execute the dynamic quantum circuit on a quantum device (e.g., quantum system 112).

During execution of the dynamic quantum circuit, the random numbers generated by the dynamic quantum circuit can be employed to determine the Paulis to be measured. As such, various embodiments of the present disclosure can utilize intrinsic randomness from a quantum device instead of employing another source of randomness to make random selections. In an implementation, unused qubits can be employed to generate quantum random numbers based on a decision diagram. Further, since the second set of quantum operations can depend on the quantum random numbers generated, the dynamic quantum circuit can be employed to both, select the Paulis to be measured, and measure the Paulis based on the selections. This can further enable efficient execution of quantum operations via the dynamic quantum circuit generated by quantum circuit generation component 110. In the past, random numbers were generated by flipping a coin, measuring a random process, etc. which are clearly inefficient methods.

For example, quantum circuit execution component 111 can select non-limiting decision diagram 900. Upon execution of the dynamic quantum circuit, the quantum random numbers generated can be employed to randomly assign probabilities for the X, Y and Z measurement bases at each level, beginning at the topmost circle of non-limiting decision diagram 900. For example, based on the quantum random numbers, quantum circuit execution component 111 can randomly select the X measurement basis, the Y measurement basis or the Z measurement basis and assign a probability to each measurement basis, such that the sum of respective probabilities assigned to each of the measurement bases equals to one. For example, quantum circuit execution component 111 can assign a probability of ⅓ to each of the X, Y and Z measurement bases. The probabilities can then be employed to choose the path on non-limiting decision diagram 900.

### Example

Decision diagrams can be employed in conjunction with the techniques disclosed herein as follows.

One or more embodiments herein can be employed to select a path in a decision diagram, based on quantum random numbers. For example, a decision diagram similar to non-limiting decision diagram 910 can be employed by quantum circuit execution component 111 in conjunction with a dynamic quantum circuit generated by quantum circuit generation component 110 to make random choices. For example, quantum circuit execution component 111 can select a decision diagram, wherein the decision diagram can have multiple paths. If a quantum random number generated by execution of the dynamic quantum circuit suggests that the measurements are to be performed in the X measurement basis (e.g., in accordance with the embodiments described with reference to FIG. 1), then a first path in the decision diagram can be chosen by quantum circuit execution component 111. Otherwise, a second path that is different from the first path can be chosen by quantum circuit execution component 111. Either path can be selected with probabilities for the measurement bases. Thereafter, the probabilities can be adjusted. The selection of the path can happen via execution of the second set of quantum operations that can be conditional upon the quantum random numbers, as described with reference to at least FIGS. 1 and 2.

The decision diagram (or decision tree) can be generated on a classical computer. Based on the decision diagram, a decision can be made about whether the first qubit of the dynamic quantum circuit is to be measured in the Y measurement basis, the second qubit is to be measured in the Z measurement basis, the third qubit is to be measured in the Y measurement basis, and so on. As such, the dynamic quantum circuit can comprise a sequence of qubits to be measured, and the measurements can be performed in a random fashion according to the path selection. Upon selection of the path, the measurements can be executed on a quantum computer. For example, if the first path is selected, the measurements can be executed in YYXX, whereas if the second path is selected, the measurements can be executed in ZZZZ. Additionally, as described with reference to FIG. 9, each measurement basis can be associated with a probability. Thus, if the first path is selected then the measurements can be executed in the XXYY measurement basis group with probability=0.91*1*0.5*1, for example. The probability can be optimized via convex programming.

The various embodiments herein can provide a number of advantages. For example, in existing quantum computing techniques for random selection, a quantum circuit can be programmed on a classical computer. The quantum circuit can be measured at the end of the quantum operations, and the measurement can be specified. According to existing techniques, two different quantum circuits, one for the YYXX group and one for the ZZZZ group, would need to be generated. Thereafter, the measurement based on the YYXX group can be appended to the measurement for the ZZZZ group. Thus, each path in the decision diagram can correspond to a different quantum circuit, resulting in five different quantum circuits, wherein each quantum circuit would be executed on a quantum computer. On the contrary, the various embodiments disclosed herein can employ only one quantum circuit because the choice of the quantum circuits can be automatically made based on the quantum random numbers generated. Thus, even with many possible paths, only one quantum circuit can suffice. Additionally, some existing techniques can generate random numbers followed by constructing a quantum circuit based on the random numbers. That is, generating the random numbers and the corresponding quantum circuit can involve two different operations that can be separate from one another, whereas the various embodiments herein can accomplish the same by employing only one dynamic quantum circuit and without creating copies of quantum circuits.

In this regard, presented below are theoretical results showing the computational advantages of the various embodiments herein.

Problem statement: Given L observables P⁽¹⁾, P⁽²⁾, . . . , P^{(L)} and a quantum circuit producing a quantum state ρ, compute the value w₁=Tr(P^{l}ρ) up to an additive error E.

### Results:

Number of samples generated via classical shadow by employing existing quantum computing techniques:

$$S ∝ \frac{log L}{{ϵ}^{2}} {max}_{l} {3}^{weight ( {P}^{l} )} ,$$

wherein S represents the number of quantum circuits that need to be executed. These techniques can be good for k-local observables.

Number of samples generated via classical shadow with decision diagrams by employing a single dynamic quantum circuit generated by quantum circuit generation component 110:

$$S ∝ \frac{log L}{{ϵ}^{2}} {max}_{l} \frac{1}{ζ ( ( {P}^{l} ) , β )} .$$

The numbers of samples generated by employing the various embodiments herein show an exponential improvement.

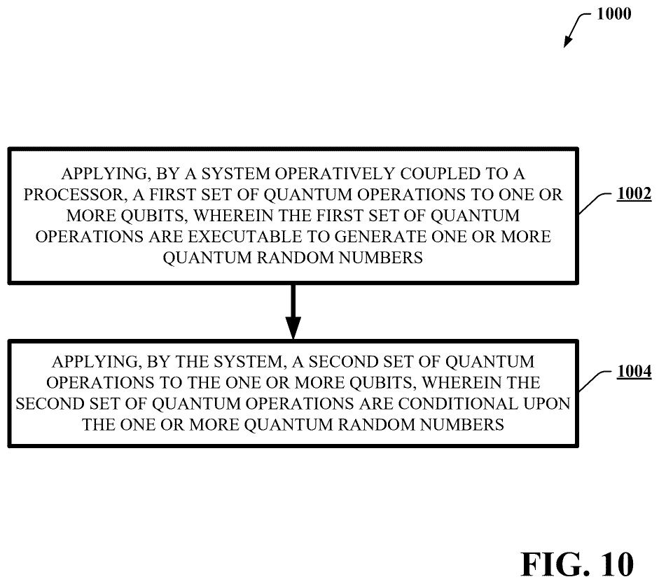

FIG. 10 illustrates a flow diagram of an example, non-limiting method 1000 that can generate and execute dynamic quantum circuits with quantum random numbers in accordance with one or more embodiments described herein. Repetitive description of like elements and/or processes employed in respective embodiments is omitted for sake of brevity.

Non-limiting method 1000 can be employed to generate a dynamic quantum circuit.

At 1002, non-limiting method 1000 can comprise applying (e.g., by quantum random number component 202), by a system operatively coupled to a processor, a first set of quantum operations to one or more qubits, wherein the first set of quantum operations are executable to generate one or more quantum random numbers.

At 1004, non-limiting method 1000 can comprise applying (e.g., by quantum random measurement component 204), by the system, a second set of quantum operations to the one or more qubits, wherein the second set of quantum operations are conditional upon the one or more quantum random numbers.

For simplicity of explanation, the computer-implemented and non-computer-implemented methodologies provided herein are depicted and/or described as a series of acts. It is to be understood that the subject innovation is not limited by the acts illustrated and/or by the order of acts, for example acts can occur in one or more orders and/or concurrently, and with other acts not presented and described herein. Furthermore, not all illustrated acts can be utilized to implement the computer-implemented and non-computer-implemented methodologies in accordance with the described subject matter. Additionally, the computer-implemented methodologies described hereinafter and throughout this specification are capable of being stored on an article of manufacture to enable transporting and transferring the computer-implemented methodologies to computers. The term article of manufacture, as used herein, is intended to encompass a computer program accessible from any computer-readable device or storage media.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

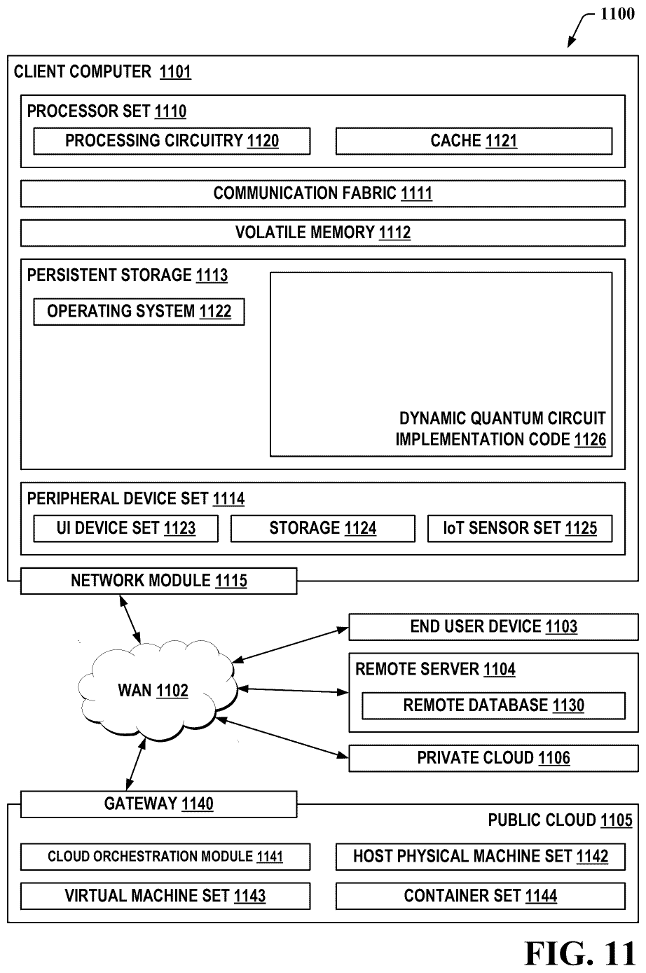

FIG. 11 illustrates a block diagram of an example, non-limiting, operating environment in which one or more embodiments described herein can be facilitated. FIG. 11 and the following discussion are intended to provide a general description of a suitable operating environment 1100 in which one or more embodiments described herein at FIGS. 1-10 can be implemented.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 1100 contains an example of an environment for the execution of at least some of the computer code involved in performing the inventive methods, such as dynamic quantum circuit implementation code 1126. In addition to block 1126, computing environment 1100 includes, for example, computer 1101, wide area network (WAN) 1102, end user device (EUD) 1103, remote server 1104, public cloud 1105, and private cloud 1106. In this embodiment, computer 1101 includes processor set 1110 (including processing circuitry 1120 and cache 1121), communication fabric 1111, volatile memory 1112, persistent storage 1113 (including operating system 1122 and block 1126, as identified above), peripheral device set 1114 (including user interface (UI), device set 1123, storage 1124, and Internet of Things (IoT) sensor set 1125), and network module 1115. Remote server 1104 includes remote database 1130. Public cloud 1105 includes gateway 1140, cloud orchestration module 1141, host physical machine set 1142, virtual machine set 1143, and container set 1144.

COMPUTER 1101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1130. As is well understood in the art of computer technology, and depending upon the technology, performance of a computer-implemented method may be distributed among multiple computers and/or between multiple locations. On the other hand, in this presentation of computing environment 1100, detailed discussion is focused on a single computer, specifically computer 1101, to keep the presentation as simple as possible. Computer 1101 may be located in a cloud, even though it is not shown in a cloud in FIG. 11. On the other hand, computer 1101 is not required to be in a cloud except to any extent as may be affirmatively indicated.

PROCESSOR SET 1110 includes one, or more, computer processors of any type now known or to be developed in the future. Processing circuitry 1120 may be distributed over multiple packages, for example, multiple, coordinated integrated circuit chips. Processing circuitry 1120 may implement multiple processor threads and/or multiple processor cores. Cache 1121 is memory that is located in the processor chip package(s) and is typically used for data or code that should be available for rapid access by the threads or cores running on processor set 1110. Cache memories are typically organized into multiple levels depending upon relative proximity to the processing circuitry. Alternatively, some, or all, of the cache for the processor set may be located “off chip.” In some computing environments, processor set 1110 may be designed for working with qubits and performing quantum computing.

Computer readable program instructions are typically loaded onto computer 1101 to cause a series of operational steps to be performed by processor set 1110 of computer 1101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1121 and the other storage media discussed below. The program instructions, and associated data, are accessed by processor set 1110 to control and direct performance of the inventive methods. In computing environment 1100, at least some of the instructions for performing the inventive methods may be stored in block 1126 in persistent storage 1113.

COMMUNICATION FABRIC 1111 is the signal conduction paths that allow the various components of computer 1101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 1112 is any type of volatile memory now known or to be developed in the future. Examples include dynamic type random access memory (RAM) or static type RAM. Typically, the volatile memory is characterized by random access, but this is not required unless affirmatively indicated. In computer 1101, the volatile memory 1112 is located in a single package and is internal to computer 1101, but, alternatively or additionally, the volatile memory may be distributed over multiple packages and/or located externally with respect to computer 1101.

PERSISTENT STORAGE 1113 is any form of non-volatile storage for computers that is now known or to be developed in the future. The non-volatility of this storage means that the stored data is maintained regardless of whether power is being supplied to computer 1101 and/or directly to persistent storage 1113. Persistent storage 1113 may be a read only memory (ROM), but typically at least a portion of the persistent storage allows writing of data, deletion of data and re-writing of data. Some familiar forms of persistent storage include magnetic disks and solid state storage devices. Operating system 1122 may take several forms, such as various known proprietary operating systems or open source Portable Operating System Interface type operating systems that employ a kernel. The code included in block 1126 typically includes at least some of the computer code involved in performing the inventive methods.

PERIPHERAL DEVICE SET 1114 includes the set of peripheral devices of computer 1101. Data communication connections between the peripheral devices and the other components of computer 1101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 1123 may include components such as a display screen, speaker, microphone, wearable devices (such as goggles and smart watches), keyboard, mouse, printer, touchpad, game controllers, and haptic devices. Storage 1124 is external storage, such as an external hard drive, or insertable storage, such as an SD card. Storage 1124 may be persistent and/or volatile. In some embodiments, storage 1124 may take the form of a quantum computing storage device for storing data in the form of qubits. In embodiments where computer 1101 is required to have a large amount of storage (for example, where computer 1101 locally stores and manages a large database) then this storage may be provided by peripheral storage devices designed for storing very large amounts of data, such as a storage area network (SAN) that is shared by multiple, geographically distributed computers. IoT sensor set 1125 is made up of sensors that can be used in Internet of Things applications. For example, one sensor may be a thermometer and another sensor may be a motion detector.

NETWORK MODULE 1115 is the collection of computer software, hardware, and firmware that allows computer 1101 to communicate with other computers through WAN 1102. Network module 1115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1115 are performed on the same physical hardware device. In other embodiments (for example, embodiments that utilize software-defined networking (SDN)), the control functions and the forwarding functions of network module 1115 are performed on physically separate devices, such that the control functions manage several different network hardware devices. Computer readable program instructions for performing the inventive methods can typically be downloaded to computer 1101 from an external computer or external storage device through a network adapter card or network interface included in network module 1115.

WAN 1102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1103 is any computer system that is used and controlled by an end user (for example, a customer of an enterprise that operates computer 1101), and may take any of the forms discussed above in connection with computer 1101. EUD 1103 typically receives helpful and useful data from the operations of computer 1101. For example, in a hypothetical case where computer 1101 is designed to provide a recommendation to an end user, this recommendation would typically be communicated from network module 1115 of computer 1101 through WAN 1102 to EUD 1103. In this way, EUD 1103 can display, or otherwise present, the recommendation to an end user. In some embodiments, EUD 1103 may be a client device, such as thin client, heavy client, mainframe computer, desktop computer and so on.

REMOTE SERVER 1104 is any computer system that serves at least some data and/or functionality to computer 1101. Remote server 1104 may be controlled and used by the same entity that operates computer 1101. Remote server 1104 represents the machine(s) that collect and store helpful and useful data for use by other computers, such as computer 1101. For example, in a hypothetical case where computer 1101 is designed and programmed to provide a recommendation based on historical data, then this historical data may be provided to computer 1101 from remote database 1130 of remote server 1104.

PUBLIC CLOUD 1105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 1105 is performed by the computer hardware and/or software of cloud orchestration module 1141. The computing resources provided by public cloud 1105 are typically implemented by virtual computing environments that run on various computers making up the computers of host physical machine set 1142, which is the universe of physical computers in and/or available to public cloud 1105. The virtual computing environments (VCEs) typically take the form of virtual machines from virtual machine set 1143 and/or containers from container set 1144. It is understood that these VCEs may be stored as images and may be transferred among and between the various physical machine hosts, either as images or after instantiation of the VCE. Cloud orchestration module 1141 manages the transfer and storage of images, deploys new instantiations of VCEs and manages active instantiations of VCE deployments. Gateway 1140 is the collection of computer software, hardware, and firmware that allows public cloud 1105 to communicate through WAN 1102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1106 is similar to public cloud 1105, except that the computing resources are only available for use by a single enterprise. While private cloud 1106 is depicted as being in communication with WAN 1102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1105 and private cloud 1106 are both part of a larger hybrid cloud.

The embodiments described herein can be directed to one or more of a system, a method, an apparatus and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that the one or more embodiments herein also can be implemented at least partially in parallel with one or more other program modules. Generally, program modules include routines, programs, components and/or data structures that perform particular tasks and/or implement particular abstract data types. Moreover, the aforedescribed computer-implemented methods can be practiced with other computer system configurations, including single-processor and/or multiprocessor computer systems, mini-computing devices, mainframe computers, as well as computers, hand-held computing devices (e.g., PDA, phone), and/or microprocessor-based or programmable consumer and/or industrial electronics. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system,” “platform” and/or “interface” can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

1. A system, comprising:
a memory that stores computer executable components; and
a processor that executes the computer executable components stored in the memory, wherein the computer executable components comprise:
a quantum circuit generation component that generates a dynamic quantum circuit, wherein generating the dynamic quantum circuit comprises:
applying, via a quantum random number component, a first set of quantum operations to one or more qubits, wherein the first set of quantum operations are executable to generate one or more quantum random numbers; and
applying, via a quantum random measurement component, a second set of quantum operations to the one or more qubits, wherein the second set of quantum operations are conditional upon the one or more quantum random numbers.

2. The system of claim 1, wherein the generating the dynamic quantum circuit further comprises:
applying, via the quantum random number component, state preparation operations to qubits in the dynamic quantum circuit, wherein the state preparation operations are executable to initialize the qubits into a desired quantum state prior to execution of the second set of quantum operations.

3. The system of claim 1, further comprising:
a quantum circuit execution component that executes the dynamic quantum circuit on a quantum computer to generate expectation values for observables, wherein executing the dynamic quantum circuit comprises:
executing the first set of quantum operations to generate the one or more quantum random numbers; and
selectively executing the second set of quantum operations, based on the one or more quantum random numbers, to generate random measurements.

4. The system of claim 3, wherein the selectively executing the second set of quantum operations increases an efficiency of execution of the dynamic quantum circuit by reducing a number of executions and reducing an execution time corresponding to the execution.

5. The system of claim 3, wherein the executing the dynamic quantum circuit further comprises repeating or executing in parallel the first set of quantum operations and the second set of quantum operations.

6. The system of claim 3, wherein the executing the dynamic quantum circuit further comprises repeating and executing in parallel the first set of quantum operations and the second set of quantum operations.

7. The system of claim 1, wherein the one or more qubits are qubits in a main register.

8. The system of claim 1, wherein the one or more qubits are auxiliary qubits.

9. The system of claim 1, wherein the one or more quantum random numbers are generated based on prior measurements and a neural network.

10. A computer-implemented method, comprising:
generating, by a system operatively coupled to a processor, a dynamic quantum circuit, wherein the generating comprises:
applying, by the system, a first set of quantum operations to one or more qubits, wherein the first set of quantum operations are executable to generate one or more quantum random numbers; and
applying, by the system, a second set of quantum operations to the one or more qubits, wherein the second set of quantum operations are conditional upon the one or more quantum random numbers.

11. The computer-implemented method of claim 10, wherein the generating the dynamic quantum circuit further comprises:
applying, by the system, state preparation operations to qubits in the dynamic quantum circuit, wherein the state preparation operations are executable to initialize the qubits into a desired quantum state prior to execution of the second set of quantum operations.

12. The computer-implemented method of claim 10, further comprising:
executing, by the system, the dynamic quantum circuit on a quantum computer to generate expectation values for observables, wherein the executing comprises:
executing, by the system, the first set of quantum operations to generate the one or more quantum random numbers; and
executing, by the system, the second set of quantum operations to generate random measurements, wherein the second set of quantum operations are executed selectively based on the one or more quantum random numbers.

13. The computer-implemented method of claim 12, wherein the executing the second set of quantum operations increases an efficiency of execution of the dynamic quantum circuit by reducing a number of executions and reducing an execution time corresponding to the execution.

14. The computer-implemented method of claim 12, wherein the executing the dynamic quantum circuit further comprises repeating or executing in parallel the first set of quantum operations and the second set of quantum operations.

15. The computer-implemented method of claim 12, wherein the executing the dynamic quantum circuit further comprises repeating and executing in parallel the first set of quantum operations and the second set of quantum operations.

16. The computer-implemented method of claim 10, wherein the one or more qubits are qubits in a main register.

17. The computer-implemented method of claim 10, wherein the one or more qubits are auxiliary qubits.

18. The computer-implemented method of claim 10, further comprising:
generating, by the system, the one or more quantum random numbers based on prior measurements and a neural network.

19. A computer program product for employing quantum random numbers to execute quantum algorithms via dynamic quantum circuits, the computer program product comprising a computer readable storage medium having program instructions embodied therewith, the program instructions executable by a processor to cause the processor to:
generate, by the processor, a dynamic quantum circuit, wherein generating the dynamic quantum circuit comprises:
applying a first set of quantum operations to one or more qubits, wherein the first set of quantum operations are executable to generate one or more quantum random numbers; and
applying a second set of quantum operations to the one or more qubits, wherein the second set of quantum operations are conditional upon the one or more quantum random numbers.

20. The computer program product of claim 19, wherein the program instructions are further executable by the processor to cause the processor to:
execute, by the processor, the dynamic quantum circuit on a quantum computer to generate expectation values for observables, wherein executing the dynamic quantum circuit comprises:
executing the first set of quantum operations to generate the one or more quantum random numbers; and
executing the second set of quantum operations to generate random measurements, wherein the second set of quantum operations are executed selectively based on the one or more quantum random numbers.
